(19) United States
(12) Patent Application Publication
(10) Pub. No.: US 2014/0078095 A1
(43) Pub. Date: Mar. 20, 2014

(54) APPARATUS FOR COMMUNICATING WITH A TOUCH SCREEN DISPLAY

(71) Applicants: Ilia Baranov, Richmond Hill (CA); Melvin Zehan Ng, Waterloo (CA)

(72) Inventors: Ilia Baranov, Richmond Hill (CA); Melvin Zehan Ng, Waterloo (CA)

(21) Appl. No.: 13/622,308

(22) Filed: Sep. 18, 2012

(51) Int. Cl. G06F 3/044; G06F 3/041

(52) U.S. Cl. 345/174; 345/173

(57) ABSTRACT

An apparatus for transferring data via a touch sensitive display of a computing device, the apparatus comprising: a processing unit; at least one switch; a plurality of conductive pads for contacting said touch sensitive display, wherein each of said conductive pads is coupled to said processing unit via said at least one switch; and wherein said processing unit controls the operation of said at least one switch to enable or disable each of said plurality of conductive pads.

### CROSS-REFERENCE TO RELATED APPLICATIONS

This application claims the benefit of priority to U.S. Provisional Application Ser. No. 61/546,993, filed on Oct. 13, 2011.

### FIELD OF THE INVENTION

The present invention relates to authentication systems, more particularly it relates to transferring authentication data via a touch sensitive display.

### DESCRIPTION OF THE RELATED ART

Loyalty programs have been used in commerce for decades as a way of gaining an advantage over competitors. The average U.S. household belongs to 14 different loyalty programs. Modern versions of this concept stem from retailers' need for a method to identify individual customers and to measure and understand their behaviours. Customers are awarded loyalty points each time they purchase a merchant's products or services. Typically, the customers' purchases are tracked using loyalty cards which are paper-based or plastic based, and can be stamped, punched, or wiped following a purchase. Upon accumulation of predetermined loyalty points within a predetermined period the customer is given a reward by the merchant, such as a rebate or free products or services. Accordingly, a customer's purchases associated with the card can be tracked and stored by the merchant. Using analytical methods, the merchant can determine a customer's purchase profile and can offer several reward tiers that entitle customers to different benefit levels customized based on their profile. Drawbacks of these loyalty cards is that they may be misplaced, damaged, lost or stolen, resulting in the customer forfeiting any of the accumulated recorded purchases associated with the card. In addition, these cards are prone to fraud, as stamping devices or punching devices can be easily duplicated, or the cards with magnetic strips may be cloned, resulting in inventory loss, including inaccurate customer behavioural data.

With the advent of smartphones, another proposed solution allows a customer to use their smartphone to capture special coded image, such as a QR code, at the point-of-sale terminal, and interpret the image to receive credit for purchases. However, the potential for fraud remains as users can capture the code and then repeatedly scan it at their convenience, without making any actual purchases. Other solutions employ a digitizer stylus with self-powered electronics that generate and transmit data to the smartphone, however, this communication is unidirectional.

It is an object of the present invention to mitigate or obviate at least one of the above-mentioned disadvantages.

### SUMMARY OF THE INVENTION

In one of its aspects, there is provided an apparatus for transferring data via a touch sensitive display of a computing device, the apparatus comprising:

a processing unit;

at least one switch;

a plurality of conductive pads for contacting said touch sensitive display, wherein each of said conductive pads is coupled to said processing unit via said at least one switch; and

wherein said processing unit controls the operation of said at least one switch to enable or disable each of said plurality of conductive pads.

In another of its aspects, there is provided a method for transferring data via a touch sensitive display of a computing device, the method comprising the steps of:

providing an apparatus having an electrically conductive portion for contacting said display;

providing a switched capacitive field to said conductive portion such that a touch event is registered at said display when said capacitive field is connected to said conductive portion in contact with said display, wherein said touch event represents message data;

at the computing device, converting said touch event to said message data.

In another of its aspects, there is provided a data exchange system comprising:

a communications device having a touch sensitive display, said display having a display controller to registering at least one touch event associated with an object contacting said display;

said object having at least one conductive portion for contacting said display, wherein at least one conductive portion is connected to a capacitive field via said at least one switch operable at a predetermined frequency, such that said at least one touch event is registered when said switch is closed with said least one conductive portion in contact with said display to generate binary data, and said predetermined frequency dictates the rate of data exchange from said object to said display; and

a non-transitory computer readable medium having instructions executable by a processor to cause the processor to determine said data associated with said at least one touch event.

Advantageously, using a signal generator, unique patterns can be transmitted without additional hardware or firmware changes on the computing devices. By periodically turning the touch event on the screen “on” and “off”, signals received on the touch sensitive display can be converted into binary data. Therefore, the oscillating frequency can be used to transfer additional data in addition to the touch event by pulsing the point of contact on the touch surface, such as a stylus tip or a conductive pad. Accordingly, data may be transferred directly from touch events registered on the touch sensitive display without the need of employing Bluetooth™, near field communication (NFC), USB, and so forth. Further, the apparatus is capable of one-way or two way communications with a touch sensitive display. Bidirectional communication between the apparatus and the touch sensitive display is desirable in applications pertaining to encryption, authentication, digital signatures, loyalty programs and gaming, and so forth,

### BRIEF DESCRIPTION OF THE DRAWINGS

Several exemplary embodiments of the present invention will now be described, by way of example only, with reference to the appended drawings in which:

FIG. 1 shows an exemplary data exchange system;

FIG. 2 shows a schematic diagram of an exemplary communications device;

FIG. 3 shows a touch sensitive display of the communications device FIG. 1;

FIG. 4 shows an apparatus for exchanging data with a communications device;

FIG. 5 shows exemplary circuitry associated with the apparatus of FIG. 4.

FIG. 6 shows an apparatus in contact with a touch sensitive display of the communications device; and

FIG. 7 shows a stylus for use in the data exchange system.

### DETAILED DESCRIPTION OF EXEMPLARY EMBODIMENTS

The detailed description of exemplary embodiments of the invention herein makes reference to the accompanying block diagrams and schematic diagrams, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented.

Moreover, it should be appreciated that the particular implementations shown and described herein are illustrative of the invention and its best mode and are not intended to otherwise limit the scope of the present invention in any way. Indeed, for the sake of brevity, certain sub-components of the individual operating components, conventional data networking, application development and other functional aspects of the systems may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

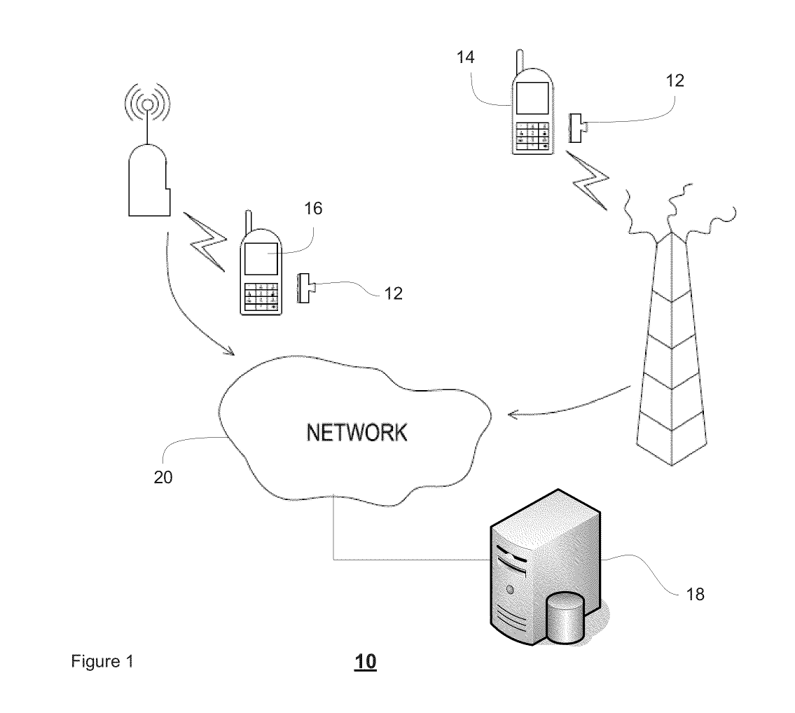

FIG. 1 shows an exemplary data exchange system, generally identified by reference numeral 10, between an apparatus 12 and a communications device 14 having a touch sensitive display screen 16. The apparatus 12 is caused to contact the screen 16 such that points of contact on the screen 16 are sensed by the communications device 14 and interpreted as a touch event, as will be explained in greater detail below. X-Y coordinates associated with a location of the points of contact on the screen 16 are thus recorded, such that the touch event provides data comprising at least the location, a timestamp, among others. The data is sent to a computing entity, such as server 18, via a network 20, where the data is analysed to verify the authenticity of the data and/or the source of the data, i.e. the apparatus 12.

The communications device 14 may be general purpose computing device, or other suitable processing device comprising, for example, a processing unit 21, system memory 22 (volatile and/or non-volatile memory), other non-removable or removable memory (e.g. a hard disk drive, RAM, ROM, EEPROM, CD-ROM, DVD, flash memory, etc.) and a system bus 23 coupling the various computer components to the processing unit 21, such as I/O devices 24 via an I/O controller 25. The communications device 14 may also comprise networking capabilities using Ethernet, Wifi™, and/or other suitable network format, to enable connection to shared or remote drives, one or more networked computers, or other networked devices. It will be apparent from this description that aspects of the present invention may be embodied, at least in part, in software. That is, the techniques may be carried out in a computer system or other data processing system in response to its processor, such as a microprocessor, executing sequences of instructions contained in memory. In various embodiments, hardwired circuitry may be used in combination with software instructions to implement the present invention. Thus, the techniques are not limited to any specific combination of hardware circuitry and software nor to any particular source for the instructions executed by the data processing system. The communication device 14 may for example include any computing device such as, a personal computer, a laptop, a tablet, a cellular phone, and a smartphone. The server 18 comprises a similar computing system as described above, however, it may further comprise data structures, such as, databases.

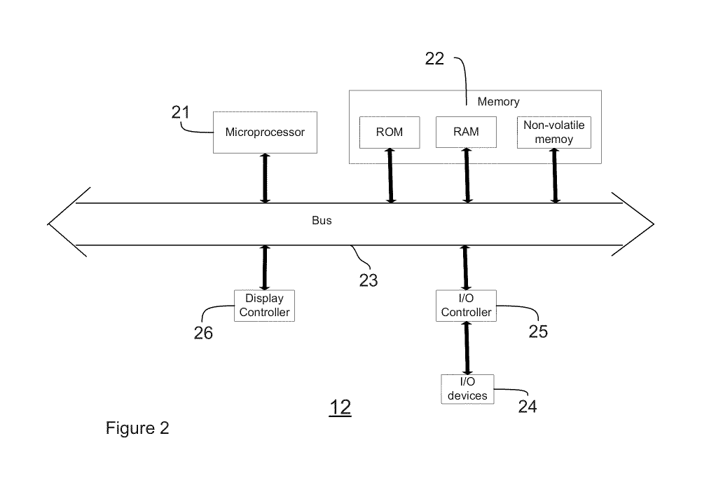

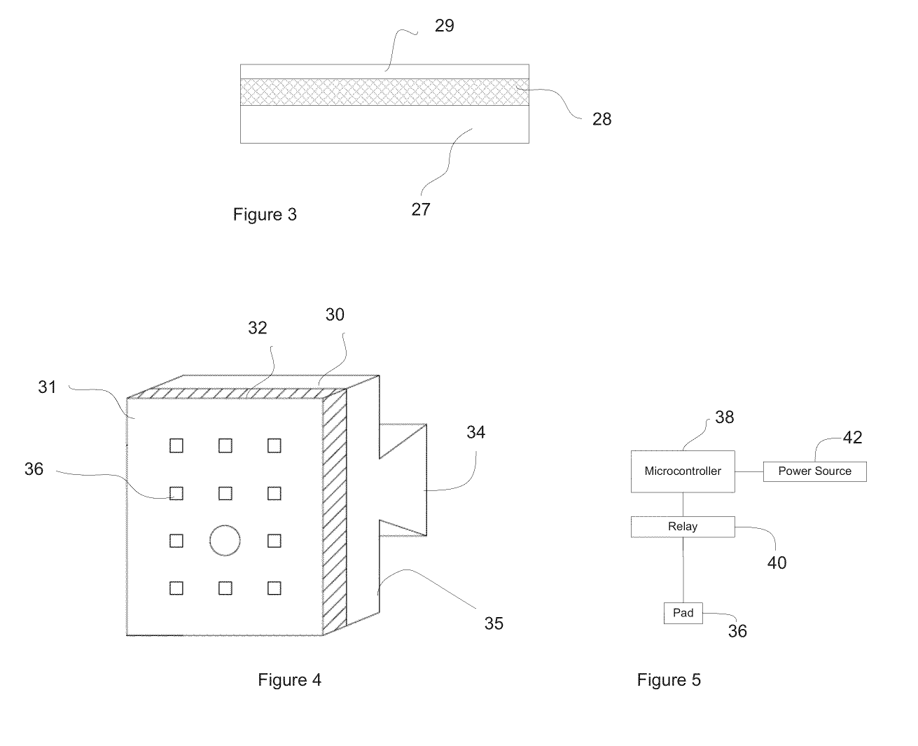

Turning to FIGS. 2 and 3, an exemplary communications device 14 in the form of a smartphone is shown, and comprises the screen 16 on which graphics, text, icons, video, and any combination thereof is displayed, and receives input data associated with touch events. A display controller 26 receives and/or sends electrical signals from/to the touch sensitive display 16.

As is well-known in the art, the touch sensitive display 16 includes a touch sensitive surface, sensor or set of sensors that accept input from the objects based on haptic and/or tactile contact. The touch sensitive display 16 and the display controller 26 (along with any associated modules and/or sets of instructions in memory) detect contact (and any movement or breaking of the contact) on the touch sensitive display 16. In more detail, the touch sensitive display 16 includes a rigid substrate 27 of suitable material such as glass or acrylic, a capacitive touch sensor layer 28 having electrode bars, and a dielectric 29. The display controller 26 drives the voltage applied to the capacitive layer 28 and receives the voltages for determination of the location of touch events by the processor 21. Using associated software on the communications device 14, the software interprets the touch pattern on the touch sensitive display 16 by translating the positions of the conductive pads 36 back into binary format. The software may be a full program or a library. In one example, a full program may be used for applications such as mobile loyalty programs.

In more detail, the apparatus 12 comprises a rectangular parallepiped shaped body 30 with one face 31 having a foam material 32 secured thereto, and a hand grip 34 on the opposing face 35, as shown in FIG. 4. The foam material 32 includes a plurality of exposed conductive pads 36, which may be flush with the foam material surface or slightly recessed within the foam material. When the apparatus 12 is pressed against the screen 16 the foam material is deformed and the conductive pads 36 make contact with the screen 16. The conductive pads 36 are made from conductive foam or soft conductive material. Typically, the conductive pads 36 are arranged in a grid pattern, and separated from each other by a predetermined distance.

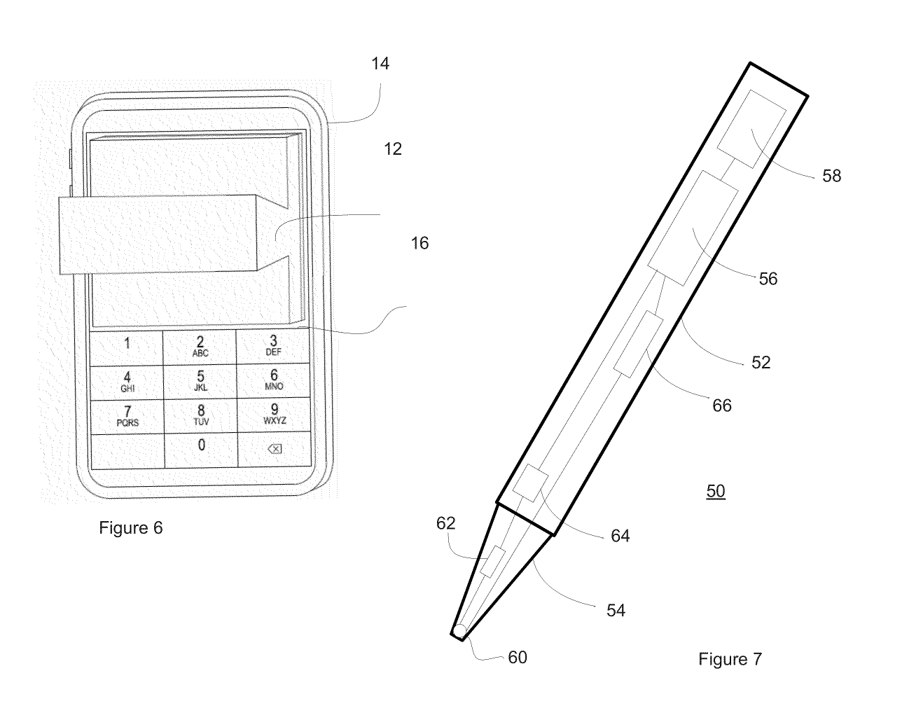

Housed within the body 30 is a microcontroller 38 which performs associated processing functions and controls individual relays 40 coupled to the individual conductive pads 36, as shown in FIG. 5. A power source 42, such as an electric double-layer capacitor (EDLC) or supercapacitor, is coupled to the microcontroller 38 to supply power thereto. Advantageously, the super capacitor 42 can be charged wirelessly by an external source such as an inductive charging pad (not shown). The relays 40 are controlled by the microcontroller 38 to connect or disconnect a user's capacitive field from the conductive pad 36 associated with a particular relay 40. The switching rate or frequency for the relays 40 may be chosen from within a predetermined range. Looking at FIG. 6, when a relay 40 connects a user's capacitive field to a conductive pad 36, the display controller 26 detects a touch at that location. Accordingly, the capacitive touch sensitive display 16 is able to detect the change of frequency on multiple points thereon and register touch events. The touch event frequencies can be either generated with a relay switch 40 connected to ground or based on a virtual grounding effect caused by running a high inductance current into a capacitance and resistance that matches a human body. The microcontroller 38 is also responsible for communicating with a real time clock (not shown), if such a device is present. In one example, when the apparatus 14 is removed from the charging pad, the microcontroller 38 causes the relay 40 to operate at the chosen frequency.

Firmware on the microcontroller 38 encodes binary data into the grid pattern or touches on the screen 16. Therefore, the microcontroller 38 dictates which of the conductive pads 36 are connected or disconnected at any given instance for a known grid pattern. For example, when the apparatus 12 comprises 4 conductive pads 36, then there are 16 possible combinations of the grid pattern based on the on or off states of the conductive pads 36. Accordingly, there are 16 possible touches on the screen 16, where each touch represents one of 16 possible states with each state having 4 bits of data, that is, 0000; 0001; 0010; 0011; 0100; 0101; 0110; 0111; 1000; 1001; 1010; 1011; 1100; 1101; 1110; and 1111. Using an exemplary switching rate of 110 Hz to the relays 40, then 40 bits/s can be transmitted to the communication device 14.

The data packet transmitted to the communications device 14 comprises a unique ID associated with the apparatus 12, time data and message data. In one example, the unique ID comprises 22 bits thus providing 4194304 unique IDs. Time data is generated from a real time clock and is represented by 26 bits, while the message data is comprised of 4 bits, that is, when using the apparatus 12 having 4 conductive pads 36, as described above. Therefore, the data includes a total of 52 bits, and at rate of 40 bits/s then it takes 1.3 seconds to transmit the data. Another exemplary apparatus 12 with 9 conductive pads 36 would provide 512 possible states, with 9 bits per state, and 90 bits/s at a switching rate of 10 Hz. Alternatively, some applications may not require a unique ID or timestamp, in which case the message data forms the entirety of the data packet. An exemplary data transmission sequence includes the steps of: (1) providing a start code associated with the orientation of the apparatus 12 in relation to the screen 16, for example, 3 conductive pads 36 simultaneously contact the screen 16 provide orientation information; (2) transmitting the data packet as specified above; (3) pausing for a predetermined time, such as ¼ seconds, to separate data packets; and (4) repeating from step 1. Therefore, touch events are generated in a specific pattern to transfer additional data along with the regular location data.

Depending on the application, the data may also be encrypted using software encryption libraries stored in the microcontroller 38 memory, in order to mitigate fraud. For example, a security key may transmitted to the touch sensitive display 16, either to unlock a communications device 14, digitally sign a document, or authenticate a transaction, such as a loyalty stamp.

Looking at FIG. 7, a stylus for use with the system 10 is shown and is generally identified by reference numeral 50. The stylus 50 comprises a body 52 with a tip assembly 54 at one end. The body 52 houses a controller 56 and a power source 58, such as a battery.

The tip assembly 54 includes an electrically-conductive tip 60 and a tip switch 62 coupled to a pressure sensor 64 electrically connected to the controller 56. The pressure sensor 64 senses a force applied on the tip 60 when in contact with a surface of the touch sensitive display 16. When the stylus 50 is brought into contact with the surface of the touch sensitive display 16, the tip switch 62 is closed and this action is sensed by the controller 56. The pressure sensor 64 sends the sensed pressure data to the controller 56 which interprets the received pressure data and determines a frequency for which the tip 60 to pulse while in contact with the screen 16. The controller 56 then instructs a pulse generator 66 to provide the appropriate signal at the desired frequency to the tip 60. Accordingly, the frequency of the pulse is correlated to the detected pressure, and so when the user presses harder on the stylus 50, then the pulsing frequency is increased.

While the tip switch 62 is closed, the location of the stylus 50 relative to the display 16 surface in (x, y) coordinates is calculated by the display controller 26. In addition to determining the location of the tool 50, a timestamp and the pulse frequency are also recorded and sent to the application via the display controller 26. The contact area of the tip 60 is also determined in relation to the sensed pressure due to the force of the tip 60 on the display 16 surface. The pulsing rate of the tip 60 is therefore detected by the display controller 26, and as the pulsing rate is correlated to the force of the tip 60 on the display 16 surface, then a low frequency results in smaller contact area while a high frequency results is a larger contact area. Should the tip switch 62 remain closed, while the (x, y) coordinates change then the display controller 26 interprets this event as a stylus 50 move event. Accordingly, a series of (x, y) coordinates indicating the position of the stylus 50 is recorded and represents a line path on the touch sensitive display 16. Once again, the width of the line path due to detected stylus 50 move events will depend on the determined contact area. Alternatively, data using well-know coding schemes, such as, Manchester encoding where both the clock and the data are synchronized may be employed. This reduces lags generated on the touch sensitive display 16 while drawing.

In one exemplary application, the apparatus 12 is used in conjunction with a smartphone 14 in a loyalty program. For example, a user enters a coffee shop and buys a beverage, and while at the point-of-sale terminal, the user runs a loyalty program application on the smartphone 14. A cashier presses the apparatus 12 onto the screen 16 of the smartphone 14 in order to transfer data related to the purchase and associated loyalty points. More specifically, the apparatus 12 transfers a data packet comprising the unique ID code associated with the apparatus 12, time, and message data into the application via the display controller 26. The contents of the data packet may be encrypted to mitigate fraud. The application then transmits the received data to a server 18, where the data is first decrypted. Next the data is analyzed, i.e. the ID is checked against a list of valid IDs, and the time is validated to be the current time. The use of a timestamp prevents multiple uses of the same data packet which, further mitigates against fraud. If the data is valid, the server 18 updates the users account with the correct amount of loyalty points, and the store's account with the user information. Lastly, the server 18 replies to the application on the smartphone 14 with an acknowledgment. However, in the event of network 20 unavailability, the application can store the data until it becomes available, and then send the data package to the server 18.

The communication network 20 can include a series of network nodes (e.g., the clients and servers) that can be interconnected by network devices and wired and/or wireless communication lines (such as, public carrier lines, private lines, satellite lines, etc.) that enable the network nodes to communicate. The transfer of data between network nodes can be facilitated by network devices, such as routers, switches, multiplexers, bridges, gateways, etc., that can manipulate and/or route data from an originating node to a server node regardless of dissimilarities in the network topology (such as, bus, star, token ring, mesh, or hybrids thereof), spatial distance (such as, LAN, MAN, WAN, Internet), transmission technology (such as, TCP/IP, Systems Network Architecture), data type (such as, data, voice, video, multimedia), nature of connection (such as, switched, non-switched, dial-up, dedicated, or virtual), and/or physical link (such as, optical fiber, coaxial cable, twisted pair, wireless, etc.) between the correspondents within the network 20.

The touch sensitive display 16 and the display controller 26 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch sensitive display 16.

In another embodiment, instead of the relay 40, other methods for generating disruptive conductive fields may be employed, such as, switched capacitors, induction coils, or solid state transistors.

In yet another embodiment, the apparatus 12 is adapted to accept input from the smartphone 14 via a light sensor placed on face 31 of the apparatus 12. The smartphone 14 rapidly changes the screen 16 brightness in a predetermined portion of the screen 16, and thus communicates information back to the apparatus 12. This communication can happen simultaneously and independently of the communication to the smartphone 14.

In yet another embodiment, the apparatus 12 includes an I/O interface, such as a USB port, for connecting peripheral devices, such as a keyboard, a mouse or a computing device 14.

In yet another embodiment, the system 10 is used in gaming applications, payment systems, security applications, such as entry systems, and digital signature applications.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises,” “comprising,” or any other variations thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical.”

The preceding detailed description of exemplary embodiments of the invention makes reference to the accompanying drawings, which show the exemplary embodiment by way of illustration. While these exemplary embodiments are described in sufficient detail to enable those skilled in the art to practice the invention, it should be understood that other embodiments may be realized and that logical and mechanical changes may be made without departing from the spirit and scope of the invention. For example, the steps recited in any of the method or process claims may be executed in any order and are not limited to the order presented. Further, the present invention may be practiced using one or more servers, as necessary. Thus, the preceding detailed description is presented for purposes of illustration only and not of limitation, and the scope of the invention is defined by the preceding description, and with respect to the attached claims.

The embodiments of the invention in which an exclusive property or privilege is claimed are defined as follows:

1. An apparatus for transferring data via a touch sensitive display of a computing device, the apparatus comprising:
a processing unit;
at least one switch;
a plurality of conductive pads for contacting said touch sensitive display, wherein each of said conductive pads is coupled to said processing unit via said at least one switch; and
wherein said processing unit controls the operation of said at least one switch to enable or disable each of said plurality of conductive pads.

2. The apparatus of claim 1 wherein said apparatus is placed on said display by a user, wherein said user is associated with a capacitive field.

3. The apparatus of claim 2 wherein said at least one switch is controlled by said processing unit to connect or disconnect a user's capacitive field from said plurality of conductive pads.

4. The apparatus of claim 3 wherein a touch event is registered at said display when said capacitive field is connected to any of said plurality of conductive pads in contact with said display.

5. The apparatus of claim 4 wherein when the number of said plurality of conductive pads equals n then said apparatus comprises 2ⁿ states corresponding to unique touch event patterns.

6. The apparatus of claim 5 wherein each state comprises n bits of data.

7. The apparatus of claim 6 wherein said at least one switch opens and closes at a predetermined frequency (f), such that the data is transmitted at a rate of nf bits/s.

8. The apparatus of claim 7 wherein said touch events on said display are converted into binary data by said computing device, such that said unique patterns are transmitted from said apparatus without additional hardware or firmware changes on said computing device.

9. The apparatus of claim 8 wherein said data comprises location data associated with said touch event, a unique ID associated with said apparatus, time data associated with said touch event and message data.

10. The apparatus of claim 9 wherein said data is encrypted by said processing unit before transmission.

11. The apparatus of claim 1 wherein said at least one switch is one of a relay, a switched capacitor, an induction coil, and a solid state transistor.

12. A method for transferring data via a touch sensitive display of a computing device, the method comprising the steps of:
providing an apparatus having an electrically conductive portion for contacting said display;
providing a switched capacitive field to said conductive portion such that a touch event is registered at said display when said capacitive field is connected to said conductive portion in contact with said display, wherein said touch event represents message data;
at the computing device, converting said touch event to said message data.

13. The method of claim 12 comprising a further step of generating a signal at a predetermined frequency to control the coupling of said capacitive field to said electrically conductive portion to produce said touch events corresponding to said frequency.

14. The method of claim 13 comprising the further steps of:
associating said touch event with time data and location data,
associating said apparatus with a unique ID;
packaging said unique ID, location data, time data and message data into a data packet; and
and transmitting said data packet to said display.

15. The method of claim 14 comprising a further step of encrypting said data packet at said apparatus.

16. The method of claim 15 wherein said apparatus is a stylus such that said conductive portion is a stylus tip which is pulsed at said predetermined frequency such additional data is encoded from multiple touch events associated with said pulsing tip.

17. The method of claim 15 wherein said apparatus comprises a plurality of conductive portions for contacting said touch sensitive display;
wherein each of said conductive portions is independently controlled by said signal; and
wherein when the number of said conductive portion equals n then said apparatus comprises 2ⁿ states corresponding to unique touch event patterns, and each state comprises n bits of data;
and wherein a frequency (f) of said signal provides a data transmission rate of nf bits/s.

18. A data exchange system comprising:
a communications device having a touch sensitive display, said display having a display controller to registering at least one touch event associated with an object contacting said display;
said object having at least one electrically conductive portion for contacting said display, wherein at least one conductive portion is connected to a capacitive field via said at least one switch operable at a predetermined frequency, such that said at least one touch event is registered when said switch is closed with said least one conductive portion in contact with said display to generate binary data, and said predetermined frequency dictates the rate of data exchange from said object to said display; and
a non-transitory computer readable medium having instructions executable by a processor to cause the processor to determine said data associated with said at least one touch event.

19. The system of claim 18 wherein said data comprises an identifier associated with said object, a time stamp associated with said touch event, location data associated with said touch event, and message data corresponding to said touch event.

20. The system of claim 19 wherein said data is sent to a computing entity for verification of said identifier and said time stamp and authentication of said message data.
